(19) United States
(12) Patent Application Publication
(10) Pub. No.: US 2007/0062458 A1
(43) Pub. Date: Mar. 22, 2007

(54) Method of supplying a decor piece for a pet habitat

(76) Inventor: Jeffrey S. Rutstein, Stamford, CT (US)

Correspondence Address: GORDON & JACOBSON, P.C., 60 LONG RIDGE ROAD, SUITE 407, STAMFORD, CT, 06902, US

(21) Appl. No.: 11/229,952

(22) Filed: Sep. 19, 2005

(51) Int. Cl. A01K 63/00

(52) U.S. Cl. 119/253

(57) ABSTRACT

A décor piece for a pet habitat is formed from a semiprecious gemstone or mineral such as calcite or amethyst which is mined and processed to provide a shiny (polished) piece having at least one characteristic dimension of between 3 and 20 inches. The décor piece is supplied to a wholesale or retail outlet for sale to the public as a décor piece for a pet habitat such as an aquatic or reptile habitat.

### BACKGROUND OF THE INVENTION

1. Field of the Invention

This invention relates broadly to pet habitat accessories. More particularly, this invention relates to pet accessories made of semiprecious minerals or gemstones.

2. State of the Art

The pet industry is a growing industry worldwide. According to the American Pet Product Manufacturers Association, in 2003, pet owners spent about $31 billion on their pets, and about $7.6 billion on pet accessories, and 62% of U.S. households own a pet. Pet accessories can be broken down into various groups, including clothing, leashes, toys, and habitat (cages, tanks, beds, etc. and décor pieces therefor).

Generally, pet habitat accessories are manufactured to be inexpensive. As a result, the pet habitat accessories often are not particularly aesthetically pleasing. For example, aquarium décor pieces tend to be made from plastics and inexpensive metals. Thus, even when a pet owner may have an expensive and large aquarium housing exotic fish, it is not uncommon to find plastic or metal décor pieces in the aquarium.

### SUMMARY OF THE INVENTION

It is therefore an object of the invention to provide a different class of pet habitat accessories.

It is another object of the invention to provide to provide beautiful pet habitat accessories made from relatively rare minerals or gemstones.

It is a further object of the invention to provide methods for bringing unusual pet habitat accessories of the invention to the marketplace.

In accord with these objects, which will be discussed in detail below, a décor piece for a pet habitat is formed from a semiprecious mineral or gemstone such as calcite or amethyst which is mined and processed to provide a shiny (polished) piece having at least one characteristic dimension of between 3 and 20 inches. The décor piece is supplied to a wholesale or retail outlet for sale to the public as a décor piece for a pet habitat such as an aquatic or reptile habitat, although the invention is not limited to those specific habitats.

According to the invention, different colored pieces are provided. Calcite may be mined as a green-colored, orange-colored, or blue-colored semiprecious mineral. Amethyst is generally purple in color. For purposes of the invention, the calcite or amethyst is preferably acid-washed in order to provide a finish (shine).

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic of a décor piece in packaging in accord with the invention.

FIG. 2 is a flow chart of the method of the invention.

### DETAILED DESCRIPTION OF THE PREFERRED EMBODIMENT

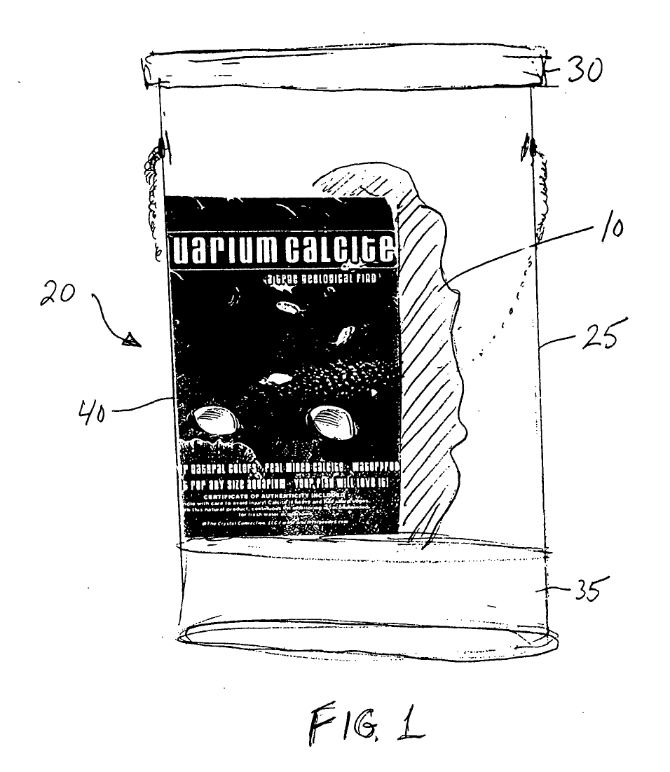

Turning now to FIG. 1, a décor piece 10 according to the invention is shown provided in appropriate packaging 20. The décor piece 10 is a piece of blue calcite having a height of approximately 7 inches and a width of approximately 4.5 inches (actual size not shown in FIG. 1). The décor piece 10 was obtain by mining a larger piece of blue calcite, and then breaking the larger piece up into smaller pieces. Smaller pieces of appropriate size (i.e., having at least one characteristic dimension of between 3 and 20 inches) were selected, and the selected smaller pieces were then subject to acid washing as is well known in the art. Piece 10 is uneven (i.e., it was not finished into a particular regular shape). If desired, in accord with the invention, décor pieces may be ground and polished to desired finished shapes.

The packaging 20 for décor piece 10 may include round plastic container 25 with a lid 30 and a foam base insert 35 on which piece 10 sits. The container 30 may be made from clear plastic through which piece 10 may be seen. Graphics 40 associated with the pet habitat in which the piece is to be used may also be displayed on or through the clear plastic. If desired, instructions and/or a certificate of authenticity as to the fact that the piece 10 is a semiprecious mineral or gemstone may be printed on the container or on a paper insert (not shown).

While a blue décor piece 10 suitable for an aquarium is shown in FIG. 1, it will be appreciated by those skilled in the art that other colored calcite could be utilized for an aquarium. Likewise, blue or other colored calcite can be used as a décor piece for other pet habitats (e.g., a reptile habitat). Also, if a purple décor piece is desired, amethyst can be used in lieu of calcite. It is believed that calcite and amethyst are the most useful semiprecious minerals and gemstones for purposes of the invention due to their cost.

As previously mentioned, since blue calcite is often mined in large pieces, it is necessary to break up the large pieces into smaller pieces for purposes of the invention. However, orange and green calcite is often mined in smaller pieces. Thus, it may not be necessary to break up those pieces. Further, pieces of blue calcite of desired size may be directly mined, so that it is not necessary to break up larger pieces.

The final size of the décor piece may vary considerably. However, in accord with the invention the décor piece should have at least one characteristic dimension of between 3 and 20 inches, and preferably at least two characteristic dimension of between 3 and 20 inches, and even more preferably, all three characteristic dimensions (height, width, and depth) of between 3 and 20 inches. More preferably, at least one, and optionally two or three of the characteristic dimensions is between 4 and 8 inches.

For purposes herein, “calcite” is to be understood as being a mineral with the general formula of ACO₃, where “A” can be one or more of several positive 2 charged metal ions such as calcium, cobalt, iron, magnesium, zinc, cadmium, manganese and/or nickel. The symmetry of the members of this group is trigonal, bar 3 2/m. The structure consists of layers of A position metal ions alternating with stacks of carbonate layers. The carbonate layers are composed of flat triangular shaped carbonate ions (CO₃), with a carbon at the center of the triangle and the three oxygens at each corner. This triangular structural element is the key ingredient in the trigonal symmetry of this group. Of course, the metal ions must also fall into place within the symmetrical arrangement in order to preserve the trigonal symmetry.

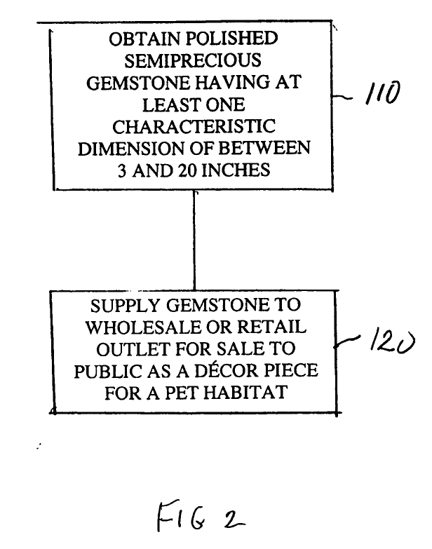

FIG. 2 shows a flow-chart of the method of the invention. As shown in FIG. 2, at 110, a semiprecious calcite or amethyst mineral or gemstone which has been mined and processed to provide a polished piece having at least one characteristic dimension of between 3 and 20 inches is obtained. The semiprecious mineral or gemstone may be obtained with or without packaging. Where packaging is not provided, preferably, the mineral or gemstone is placed into desired packaging such as shown in FIG. 1. The mineral or gemstone is then supplied at 120 to a wholesale or retail outlet for sale to the public as a décor piece for a pet habitat. The wholesale or retail outlet may be a pet supply wholesaler or retailer which may sell to the public through the internet, through retail stores, or otherwise.

There have been described and illustrated herein embodiments of a method of supplying décor pieces for pet habitats. While particular embodiments of the invention have been described, it is not intended that the invention be limited thereto, as it is intended that the invention be as broad in scope as the art will allow and that the specification be read likewise. Thus, while particular types of pets have been disclosed, it will be understood that décor pieces for other pets such as cats, rabbits, etc., can be used. It will therefore be appreciated by those skilled in the art that yet other modifications could be made to the provided invention without deviating from its spirit and scope as claimed.

1. A method of supplying a décor piece for a pet habitat, comprising:
obtaining a semiprecious calcite or amethyst which has been mined and processed to provide a shiny non-molded piece consisting essentially of a single piece of calcite or amethyst having at least one characteristic dimension of between 3 and 20 inches; and
supplying the shiny non-molded piece to a wholesale or retail outlet for sale to the public as a décor piece for a pet habitat.

2. A method according to claim 1, wherein:
said semiprecious calcite or amethyst is calcite.

3. A method according to claim 2, wherein:
said calcite is blue, green or orange in color.

4. A method according to claim 1, wherein:
said semiprecious calcite or amethyst is amethyst.

5. A method according to claim 1, wherein:
said processed comprises acid washing.

6. A method according to claim 5, wherein:
said processed further comprises breaking a large mined stone into smaller pieces.

7. A method according to claim 6, wherein:
said processed further comprises selecting from said smaller pieces a plurality of pieces having said at least one characteristic dimension.

8. A method according to claim 1, wherein:
said characteristic dimension is between 4 and 8 inches.

9. A method according to claim 1, wherein:
said at least one characteristic dimension of between 3 and 20 inches comprises at least two characteristic dimensions of between 3 and 20 inches.

10. A method according to claim 9, wherein:
said at least two characteristic dimension of between 3 and 20 inches comprises three characteristic dimensions of between 3 and 20 inches.

11. A method according to claim 1, wherein:
said wholesale or retail outlet is an internet site.

12. A method according to claim 1, wherein:
said wholesale or retail outlet is retail store.

13. A method according to claim 1, wherein:
said pet habitat is an aquarium or a reptile habitat.

14. A method according to claim 1, wherein:
said shiny piece has an irregular shape.

15. A method according to claim 1, wherein:
said shiny piece has an regular shape.

16. A method of supplying a décor piece for a pet habitat, comprising:
obtaining a semiprecious calcite which has been mined and processed with acid washing to provide a polished non-molded piece consisting essentially of said semiprecious calcite having a first characteristic dimension of between 4 and 8 inches, and at least one other characteristic dimension of between 3 and 20 inches; and
supplying the polished non-molded piece to a wholesale or retail outlet for sale to the public as a décor piece for an aquarium or reptile habitat.
